(19) United States
(12) Patent Application Publication
(10) Pub. No.: US 2017/0091801 A1
(43) Pub. Date: Mar. 30, 2017

(54) ELECTRONIC INTEGRATED COUPON LOYALTY PROGRAM SUPPORT SYSTEM

(71) Applicant: Gabriel Ben-Zion Rothberg, Los Angeles, CA (US)

(72) Inventor: Gabriel Ben-Zion Rothberg, Los Angeles, CA (US)

(21) Appl. No.: 14/864,780

(22) Filed: Sep. 24, 2015

(51) Int. Cl. G06Q 30/02; G06Q 40/02

(52) U.S. Cl. CPC G06Q 30/0226; G06Q 30/0225; G06Q 30/0238; G06Q 40/02

(57) ABSTRACT

The Integrated Electronic Coupon Loyalty Program Support System equips the POS site to determine when a coupon should be awarded, reimburses the consumer and generates an electronic coupon record for settlement between merchandisers and the product manufacturers.

The system provides the following advantages:
it appeals to millennials and other consumers comfortable with using the Internet, workstations and mobile devices rather than cutting and collecting paper coupons or images and bringing them to the POS site,
it automates many facets of coupon processing
it eliminates the costs of designing, creating and distributing paper coupons and the waste resulting when coupons are not used,
it provides Internet access to information helping consumers plan their shopping trips
the electronic coupon record links the consumer, the product purchased, the time of the purchase and the site where the purchase took place facilitating settlement and providing detailed historical information regarding the use of coupons.

### BACKGROUND OF THE INVENTION

The use of coupons to obtain savings when purchasing products is a popular concept accepted by consumers that has been in existence for many years and continues to be used today. In addition to paper coupons, coupons are now distributed in electronic image format over the Internet and can readily be accessed and obtained by consumers over the Internet using workstations, personal computers and mobile devices. Today, many of the coupons made available to consumers are issued by product manufacturers (the organizations that own and control the product).

The processing of manufacturer offered coupons begins with manufacturers designing, creating and distributing coupons that are collected by consumers. Consumers present the coupons to merchandisers, who control the POS sites where the purchase takes place, when they purchase a qualified product in accordance with coupon terms. At the time of purchase the merchandiser obtains the coupon from the consumer and immediately rebates the value of the coupon to the consumer. The merchandiser then presents the coupon to the manufacturer for reimbursement. The settlement process results in merchandisers being reimbursed for the coupons they present and manufacturers being charged for the coupons processed and associated handling fees. The settlement process involves a tedious time-consuming set of procedures where the physical coupon moves from the POS site to the manufacturer for settlement.

There are many ways to improve the efficiency and effectiveness of current coupon processing procedures from the point of coupon initiation through distribution and settlement between manufacturers and merchandisers.

My invention, the Integrated Electronic Coupon Loyalty Program Support System, provides a new approach for the generation, distribution and settlement of manufacturer coupons. Key features and benefits distinguishing my approach include the following:
1. Current paper and electronic image coupons are eliminated and replaced by electronic coupon records that are generated at the POS site when a qualified consumer loyalty program member purchases a qualified product offering a coupon rebate.
2. The consumer does not have to clip coupons, collect and organize coupons or present coupons to the merchandiser at the time of purchase.
3. The SKU (stock keeping unit) product identification scheme currently used by the grocery industry for inventory management and product sales is extended to the coupon area enabling the POS site system to award a coupon rebate for qualified manufacturer products, record the rebate on the consumer's checkout register receipt and generate an electronic coupon record at the time of purchase for each product where a coupon rebate was issued to the consumer.
4. The electronic coupon record, which contains the consumer identity, date/time of the purchase, the product purchased, the POS site where the purchase took place and the rebate amount, is created in a standard format that facilitates transmission from the merchandiser to a central servicing organization for settlement between the merchandiser who owns the POS site and issued the coupon rebate to the consumer and the product manufacturer who offered the coupon rebate award.
5. The linkage of the key information elements on the electronic coupon record deters fraud unlike current coupon processing methods involving separate processing steps which can more readily result in coupons being presented for reimbursement without having fulfilled the purchase term requirements.
6. My coupon rebate processes require consumer interactions designed to appeal to millennial consumers and other present day consumers who are comfortable using computers and smart mobile devices and are less prone to clip, collect and organize manual or electronic image coupons and bring them to POS sites for presentment at the time of product purchase.
7. Costs associated with coupon design, production and distribution are eliminated.
8. Costs associated with paper coupon presentment, validation and settlement are eliminated and the timeframe for settlement is significantly shortened.
9. Checkout processes at merchandiser POS sites are expedited by eliminating the need of validating paper coupons, entering them at the register to record the payment of a coupon rebate to the consumer and gathering, packaging and sending paper coupons for presentment to manufacturers and settlement.
10. Since my electronic coupon records are only generated after the product purchase is consummated the waste associated with the many coupons currently not used and redeemed is eliminated.
11. The consumer is no longer required to bring a coupon to the POS site to earn a rebate since the POS site tracks the availability of manufacturer coupon rebates and when a qualified coupon loyalty member consumer purchases a qualified manufacturer product, the POS site system automatically reimburses the consumer and generates an electronic coupon record supporting the settlement process between manufacturers and merchandisers performed by the central organization.

In summary, while present coupons are quite popular there is much inefficiency in the present generation, distribution, reimbursement and settlement processes performed today.

My invention, the Integrated Electronic Coupon Loyalty Program Support System, provides many improvements when compared to current manufacturer coupon processing procedures and can coexist with and eventually replace the current coupon processing procedures in place today.

### BRIEF SUMMARY OF THE INVENTION

The Integrated Electronic Coupon Loyalty Program Support System is a new approach for performing many coupon generation, distribution, processing, reimbursement and settlement processes more efficiently and effectively.

The system is managed and administrated by a central organization supporting many of the interfaces and interactions with consumers, manufacturers and merchandisers beginning with aiding consumers when planning their shopping trip through supporting the settlement between associated product manufacturers and merchandisers for their involvement with coupon rebates made to qualified coupon loyalty member consumers purchasing qualified products at merchandiser POS sites.

This system's coupon rebate processes that require consumer interaction are designed to appeal to millennials and other current day consumers accustomed to using the Internet, workstations, personal computers and mobile processing devices to support their shopping activities. It eliminates the need for consumers to clip, collect and organize coupons and brings them to the merchandiser's POS site for presentment in order to receive a coupon rebate.

The system extends the use of the SKU product identification scheme currently used in the grocery industry for inventory management and sales to the coupon area. Unique SKU product identifiers for all manufacturer products are used when communicating the availability of coupon rebates, and generating electronic coupon records for qualified purchases where coupon rebates are awarded.

The system generates an electronic coupon record when a qualified consumer loyalty program member purchases a product where the manufacturer offers coupon savings for the time period and geographical area where the purchase took place at a merchandiser POS site equipped to support the system. The electronic coupon record generated is in a format ready to transmitted to the central organization for settlement processing. The generation of a structured electronic coupon record at the time of sale documenting the specific product purchased and the coupon rebate amount eliminates waste associated with the design, production and distribution of many coupons that are never used and never redeemed by consumers.

Since the electronic coupon record is not generated until after the sale has occurred, coupon information identifying the consumer, specific product sold, time of sale, POS site and rebate amount have been determined at the POS site and can be included on the electronic coupon record generated.

The linkage of the consumer, product, point of sale site with the purchase transaction is also an effective fraud deterrent helping ensure that all parties complied with the terms of coupon use.

The system's back office processes developed, furnished and supported by the central organization employ cloud computing, Internet access and database management techniques that enable the reimbursement of merchandisers for coupons earned by consumers shopping at their POS site and charging coupon costs to appropriate product manufacturers.

As a bi-product of processing, historical coupon electronic records are generated linking consumers, products purchased, point of sale locations where transactions occurred, the date and time of the underlying product sale and the amount of coupon rebate savings earned by the loyalty member consumer. This information can be selectively provided to consumers, manufacturers and merchandisers enabling them to continuously refine, improve and expand their use of the Integrated Electronic Coupon Loyalty Program Support System.

The Integrated Electronic Coupon Loyalty Program Support System can co-exist with present day coupon processing systems and ultimately gain consumer, manufacturer and merchandiser support resulting in the replacement of many current systems and processing procedures.

### BRIEF DESCRIPTION OF THE DRAWINGS

Not applicable, there are no drawings submitted.

### DETAILED DESCRIPTION OF THE INVENTION

The Integrated Electronic Coupon Loyalty Program Support System is managed and administrated by a central organization. The central organization is responsible for maintaining all supporting databases, processing procedures and user interfaces supporting consumer, manufacturer and merchandiser activities. The central organization provides help desk support to all users, maintains all application software and database components, provides electronic coupon templates required to gather consumer, manufacturer and merchandiser supplied information, provides merchandisers with daily electronic coupon files used to update their POS site information used for electronic coupon generation, collects electronic coupon records from merchandisers for settlement and performs all electronic coupon settlement activities.

The central organization establishes product categories to facilitate the management of product data provided by manufacturers. The central organization manages the establishment and ongoing maintenance of all manufacturer and merchandiser master records. The central organization maintains a geo code (five digit zip codes) master and a combined manufacturer product master (SKU identified products for which manufacturer coupons can be awarded).

Before electronic coupon records can be provided for a product, the manufacturer must establish a product master record having a unique SKU identifier, description and image record. The product master record includes linkage to a product category and to a product manufacturer (the owner and controller of the product).

The manufacturer and their designated administrators complete Electronic Coupon Rebate Update File records via the Internet defining the terms for electronic coupon rebate offerings associated with a product. For efficiency records can cover combinations of ranges of products, ranges of time periods (start and end dates) and ranges of geographic areas (zip codes) and specify the value of the coupon rebate to be generated when a qualified consumer coupon loyalty member purchases a qualified product offering a coupon rebate at a merchandiser POS site.

The central organization uses the rebate update information received from manufacturers to create a POS Site Update File that is used to distribute product rebate information to merchandisers. The POS Site Update File is used by the merchandisers to update POS sites to identify product purchases that trigger a rebate to the consumer and generation of an electronic coupon record sent to the central organization where it is used for settlement between merchandisers and manufacturers.

The merchandiser and their designated administrators maintain POS site records for all operational sites under their control that support consumer coupon rebates and electronic coupon record generation.

Consumers must establish coupon loyalty program member accounts to participate in the Integrated Electronic Coupon Loyalty Program Support System. To facilitate validation during shopping trips, linkages can be established between the coupon loyalty program and a merchandiser's loyalty program where only one loyalty member record would be required to validate membership.

The core of the Integrated Electronic Coupon Loyalty Program Support System is the supporting central database management system. Components of this system provide coupon information to consumers maintained at an Internet site accessible nationally. This same database management system has components supporting the POS coupon generation, distribution, reimbursement and settlement processes triggered at the time of purchase of a manufacturer product qualified for coupon rebates. The same database management system maintains a history of coupon issuance and redemption activities and all associated fund transfers. This information is used for monitoring and audit review purposes as well as providing manufacturers and merchandisers with information needed to evaluate the program and fine tune plans for effective future coupon use. Key database components include the following:

Central Organization Manufacturer Product Master—Contains the product SKU identifiers and descriptive information required for coupon issuance. The product SKU identifiers are those assigned by the manufacturers and used by POS site systems to record product sales. All products are assigned to a manufacturer (the owner or controller of the product) and to a product category. This file is a consolidation of all Manufacturer Product Master files containing all products where manufacturer rebates may be offered. Product Category Master—This file contains a master record for each product category. Each product must be assigned to a valid category. Products are organized by category to aid consumers when planning a shopping trip and using the Internet site to determine available coupons. The central organization controls the Product Category Master. Geo Code Master—This file contains all geo codes (5 digit zip codes). Every merchandiser site is linked to a geo code based on its geographical location. The use of geo codes enables manufacturers to provide coupon rebates for purchases taking place in specific geographical locations.

Manufacturer Master File—Every Manufacturer must have a valid master file record before any products can be associated with the manufacturer and product related coupon record templates processed. The Manufacturer (the owner or controller of a product) is the only one who can issue manufacturer product coupons. The manufacturer master record contains address and contact information for the Manufacturer and the bank account to be charged (including router information) for coupon rebates and any related service fee charges.

Manufacturers Administrator Master—This database component is used to establish a master record for administrators who can maintain manufacturer master records and maintain a manufacturer's coupon template information used for the generation of electronic coupons for the manufacturer's products.

Manufacturer Product Master—Contains the product identifiers and descriptive information required for coupon issuance. The product identifiers are those currently assigned by the manufacturers and used by POS systems to record product sales. All products are assigned to a manufacturer (the owner or controller of the product) and a product category. This file is used by a Manufacturer to maintain products they control. The information is merged into the Central Organization Manufacturer Product Master for all products controlled by the central organization.

Merchandisers Master—Every Merchandiser supporting POS sites where electronic coupon records are generated must have a valid master file record before any POS sites for coupon generation can be established. This database component contains address and contact information for the merchandiser and the bank account where funds will be transferred to reimburse the merchandiser for consumer coupon rebates (including router information) and any related service fee earnings.

Merchandiser Administrator Master—This database component is used to establish a master record for all administrators who can maintain a merchandiser's site records. Merchandiser POS Site Master—This component is used to establish a record for every POS site owned by a merchandiser that will be used to award coupon rebates and generate electronic coupons records. Each site is assigned to a geo code (five digit zip code).

Electronic Coupon Rebate Update File—Records on this file are input by the manufacturer administrators to establish rebate coupon offers. There is a header component where the manufacturer, manufacturer administrator and date are entered. There are a variable number of trailer records completed. A trailer record contains an SKU product identifier range, a geo code range, a date range and a coupon rebate amount. These ranges enable a single trailer record to cover combinations of many products, geo codes and dates when a rebate is offered. For example, if the SKU range includes 5 products and the geo code range includes 10 zip codes and the date range is 20 days a single trailer record covers 5×10×20 combinations or 1000 different combinations. This form enables manufacturer administrators to maintain rebates for many products, in many geographical areas for ranges of days in an efficient manner. The information submitted on the Electronic Coupon Rebate Update File is moved to a Master Electronic Coupon Rebate Update File maintained by the central organization. The central organization file has an active segment used in the creation of POS site coupon rebate extensions and a historical segment that is no longer used. The active segment is searched where records with date ranges including the current POS site posting date being updated are expanded using the SKU Identifier range and geo code range creating a record for every unique SKU/geo code combination. The resulting records are sorted by geo code/SKU and are added to the Master POS Site Update File distributed by the central organization to merchandisers and used by merchandisers for updating their POS sites. Master POS Site Update File—Merchandisers are provided with a subset of the Master POS Site Update File including geo code records for all geo codes where they have POS sites operating. The merchandiser administrators match the POS Site Update File records by geo code with the POS file of each of their sites located in the geo code and update the coupon rebate amounts for matching records (non-matching records are products having rebates but not sold at the POS site and not maintained on the POS site file). This update prepares the POS site file for the provision of coupon rebates to qualified coupon loyalty program member consumers and the generation of electronic coupon records used during settlement processing when a qualified coupon loyalty program member purchases a qualified product offering a coupon rebate award.

Loyalty Program Consumer Master—Every consumer participating in the program must first enroll and establish a valid master record. Aside from name and demographic information, the consumer may supply a valid debit or credit card to be used for identification and membership validation. The consumer may also supply a phone number to be used for membership validation and to activate the coupon rebate and electronic coupon generation process. The use of a phone number will enable other family members to activate the loyalty program coupon generation process. Linkages to merchandiser loyalty programs may also be established using this file. Consumer qualification as a member of the coupon loyalty program can be validated through linkage to the merchandiser's loyalty program making validation easier when appearing at a site for a shopping trip.

Merchandiser Daily Electronic Coupon Record Transaction File—This file contains the daily electronic coupon records generated when member consumers earn coupon rebates during their shopping trips. A record on this file includes the qualified loyalty consumer member, the product, the product manufacturer, the merchandiser, the POS site, the coupon value and the date/time of the shopping trip. This file is assembled by merging records from all merchandiser site files into a single file to be sent to the central organization for settlement.

The system is designed to provide immediate gratification to the consumer when they complete their shopping trip and leave the POS site. The consumer is immediately compensated for all coupon rebate earnings associated with their shopping trip. As part of the settlement processing performed each day the electronic coupon records submitted to the central organization by merchandisers are used to generate reimbursements to merchandisers and charges to manufacturers for their product coupon rebates and associated service fees. This information is consolidated into history files to support reporting to manufacturers and merchandisers historical information relevant to them and to report rebate earnings to consumers. The information collected on this file can be used to monitor consumer activity to detect any inordinate use or abuse and can be used to review consumer trip activity.

Daily Financial Transaction File—During the end of day processing the transactions on the Daily Electronic Coupon Transaction File are used to generate financial transactions to settle coupon generation activity for the day with manufacturers and merchandisers.

This process creates the day's recap of reimbursements to consumers (already paid by the merchandiser at the POS site), reimbursement for coupon payment and service fee payments to merchandisers and charges for coupon payments and service fee payments to manufacturers. All financial transactions are posted and accumulated in a history file for monitoring and subsequent review. A summary recap of merchandiser payments and manufacturer charges is used to send electronic fund transfers to merchandisers and manufacturers using routing information maintained by the central organization. Key start-up processing procedures to complete before coupon loyalty members can be established include the following:

The Product Categories Master is established by the central organization at the outset and expanded/modified as needed. These categories are universal and used by all manufacturers entering products to the Product Master.

Each manufacturer must be established on the Manufacturer Master File and manufacturer administrators established on the Manufacturer Administrator File. The manufacturer completes Product Records on the Product Master File for all products they control for which electronic coupons will be offered. Each Product has a unique SKU identifier and is linked to a Manufacturer (controlling organization) and a product category.

Each merchandiser must be established on the Merchandiser Master File and merchandiser administrators established on the Merchandiser Administrator File. The merchandiser completes a POS Site Master record for each POS site the merchandiser controls. All POS sites are linked to a merchandiser and a geo code (five digit zip code) indicating where the site is located.

### Ongoing Processing Procedures:

Once manufacturers and merchandisers are established the key ongoing processing involves manufacturers updating the Electronic Coupon Rebate Update File records noting product purchases that earn coupon rebates. These records are used by central organization to generate the days POS Site Update File sent out to merchandisers to update their POS sites enabling the sites to provide coupon rebates and to generate electronic coupon records when a qualified coupon loyalty member consumer purchases a product qualified for a coupon rebate.

The electronic coupon records are sent from the POS sites to the merchandiser's central office and then to the central organization for settlement processing.

The central organization performs all settlement processes and updates historical files reflecting the results of settlement including rebates paid to loyalty member consumers, charges to manufacturers and payments to merchandisers.

Manufacturers are provided with timely transaction information by the system needed to plan their continued use of electronic coupons to achieve advertising, promotion and sales goals.

Merchandisers are provided with timely transaction information enabling them to plan their advertising to encourage consumer shopping trips to earn coupon rebates at their POS sites.

Consumers are provided an opportunity to proactively take advantage of electronic coupon offers available at the POS site they visit. To take advantage of the Integrated Electronic Coupon Loyalty Program Support System a consumer must first enroll and establish an active coupon loyalty member account.

Key Integrated Electronic Coupon Loyalty Program Support System characteristics: The more shopping trip planning performed by the consumer the more likely they will purchase items that qualify for coupon rebates and result in triggering the coupon record generation process. However, even without much planning and upfront effort prior to their trip to the market, qualified coupon loyalty member consumers may complete the membership validation process at the POS site and still benefit from the program by purchasing items that a manufacturer coincidently is promoting using coupon rebates. Rather than distributing paper coupons merchandisers may provide advertisements and signage to aid in the identification of items having associated coupons rebates that day. A key benefit of the Integrated Electronic Coupon Loyalty Program Support System is that the consumer is not required to bring and provide paper or image coupons to earn rebates. The POS site is equipped with rebate award information to award a rebate when a qualified consumer member purchases a qualified product.

Aside from shopping trips using POS sites, it is anticipated that all consumer interaction with system will take place over the Internet by accessing the designated Internet site and logging on to their account.

As noted, consumers can access the Internet site to plan future shopping trips to maximize their rebate earnings by taking advantage of the electronic coupon generation process. Consumers can also access the Internet site to view recent history showing reimbursements received for shopping trips completed within a specified timeframe. This historical information should confirm to them the financial value of their participation in the coupon loyalty program.

The primary transaction processing takes place at the POS site resulting in a coupon rebate being earned and electronic coupon records generated which are sent to the central organization where they are used for settlement processing. As noted above, an important feature of the system is its ability to provide immediate consumer gratification by generating and distributing coupon rebates to the member consumer at the POS site reflecting the results on their register tape.

The other key set of transactions is generated at the end of the day by the central organization during the daily settlement process where all financial transactions are generated, processed and posted to history files to support reporting and inquiries.

### Security Features:

Since the system utilizes sensitive consumer information it is critical that appropriate access controls be maintained so information is not compromised or falls into unauthorized hands. Therefore, cloud computing processes put in place and all electronic information transfers between POS sites and the central system are protected by controls required by the Payment Card Industry (PCI) as dictated by their data security standards. It is anticipated that all POS sites to be supported by this system are already subjected to these control standards.

All master file updates processed within the system will be time stamped and note the users involved during transaction processing. All electronic coupon records generated will identify the time and site where they were generated and the consumer receiving the reimbursement. Adequate information is collected to effectively validate the accuracy and validity of information and identify any suspect or unusual entries requiring further investigation.

### Recap of Some Key Advantages Provided by the Coupon Loyalty System:

1. Detailed transaction data is collected and monitored by product, manufacturer, consumer and site to detect any unusual processing or failures to comply with electronic coupon template rules in effect for a particular date and geographical location. This history can also be used to investigate and resolve any subsequent consumer complaints regarding reimbursements received.
2. Manufacturers will be able to use electronic coupons to save graphic design preparation, printing and publishing/placement costs associated with paper coupons.
3. Faster and more efficient issuance processes and more timely and comprehensive reports of distribution results by geographical area will enable manufacturers to use coupons more effectively to support sales strategies.
4. Consumers will be able to enjoy the benefit of coupons without committing time to the collection, clipping, organizing and management processes. At their option they will be able to increase their coupon benefits by preplanning trips to the market and maximizing use of available coupons by first studying information on an Internet site showing manufacturers coupons available by product category and date in their geographical area.
5. Merchandisers will be reimbursed daily for coupons processed at their POS sites since the coupon value and any associated service fees will be charged to the manufacturer and collected daily.
6. Merchandisers will be relieved of the tedious review, validation, acceptance and presentment for reimbursement processes required for present paper coupons.
7. Coupon usage information will be collected by POS site by product and can be made available for analysis by manufacturers and merchandisers to aid sales and procurement decisions.
8. Timely feedback heightens the potential for using coupons to adjust product prices to increase sales in geographical locations where there is a surplus of product on hand, to support targeted marketing campaigns and to expediently adjust coupon values when needed to influence product sales demand.
9. The direct linkage of electronic coupons to the underlying POS transactions eliminates fraudulent activities such as the production and presentment of counterfeit coupons, the processing of expired coupons and the redemption of coupons where member consumer purchasing requirements are not met.
10. The system uses existing SKU product identification to support the coupon generation process so there is no need to introduce new unfamiliar coding schemes.
11. Consumers will switch to this more effective and less tedious method of obtaining product coupons and gravitate to shopping at POS sites that support this loyalty system.

I claim as my invention:

1. A multi-step process for creating and distributing a Master POS Site Update File for merchandisers to use in updating their POS site systems to issue coupon rebates to qualified consumer loyalty system members when they purchase manufacturer products where coupon rebates are awarded and to generate electronic coupon records used for settlement comprising the following processes;
provide manufacturer administrators with a transaction screen accessible via the Internet where they can enter updates to the Electronic Coupon Rebate Update File for products controlled by the manufacturer indicating the rebate amount offered when a qualified consumer coupon loyalty system member purchases the product during a specified timeframe at a POS site located in a specified geographical area by completing a transaction header including fields to identify the manufacturer, the manufacturer administrator and the date of the transaction entry and completing a variable number of detail transaction trailer record components where for each detail transaction trailer record the manufacturer administrator enters a beginning and ending range of SKU product identifiers, a beginning and ending range of geo codes, a beginning and ending date range and a coupon rebate value,
the SKU product identifiers are edited by comparison to the Manufacturer Product Master for validity, the geo codes are edited by comparison to the geo code master containing all geo codes maintained by the central organization, the beginning date must equal or exceed the earliest date where merchandiser POS site files can be updated and the ending date must be equal to or greater than the beginning date,
the records provided by the manufacturer administrator are added to a Master Electronic Coupon Rebate Update File controlled by the central organization and remain active on this file until the ending date on the detail transaction trailer record is earlier that the next merchandiser POS site date to be updated at which time the record is moved to a history file,
when generating the Master POS Site Update File containing the coupon generation records to be sent by the central organization to merchandisers to update their POS site files each active record on the Master Electronic Coupon Rebate Update File maintained by the central organization is reviewed and if the date of the POS site update is included in the coupon generation extension date range the record is used to generate a POS site file update record for each unique combination of SKUs and geo codes included in the SKU range and geo code range of the coupon generation extension record with the total amount of the coupon rebate appended to each record created,
the master POS Site Update File is sorted by geo code and SKU and a subset of the file is sent to each merchandiser containing all records that match the geo codes of that merchandiser's POS sites,
the merchandiser administrators use the POS Site Update File received to update each of their POS sites where all coupon generation records on the file provided having the same geo code as a merchandiser site are matched to the site POS site file by SKU and when a match is found the coupon rebate amount is entered on the site POS file SKU record in the coupon rebate amount field and if an SKU does not match to the site POS file it is bypassed assuming the product is not available for sale at that site,
upon completion of the above steps the POS site file is updated reflecting the rebates to be awarded to qualified loyalty coupon consumers when a product having a coupon rebate is purchased and this information is used in generating an electronic coupon record for each rebate awarded to consumers at the merchandiser POS site.

2. The generation of an electronic coupon record when a qualified loyalty coupon consumer purchases a product having a coupon rebate award where the merchandiser POS site provides a rebate to the consumer and generates an electronic coupon record that is transmitted to the central organization to initiate the settlement process where associated product manufacturers are charged and POS site merchandisers are reimbursed for the rebate amount and associated handling charges comprising the following processes;
an electronic coupon record is generated including the date/time of purchase, the site where the purchase took place, the consumer loyalty member's number, the SKU identifier of the product purchased and the rebate amount paid to the consumer,
this record is sent from the POS site to the merchandiser's central office and then to the central organization for settlement,
the electronic coupon record is generated in a structured electronic format after the purchase has taken place and it is ready to be sent to the central organization for settlement,
the electronic coupon record links the consumer, product SKU identifier and merchandiser information and contains the rebate amount already paid to the consumer by the merchandiser,
the SKU identifier is used together with the Central Organization Manufacturer Product Master to identify the manufacturer to be charged since every product SKU is controlled by a specific manufacturer responsible for reimbursing the merchandiser for rebates awarded regarding their products.

3. The use of a specific set of procedures by the central organization to perform the settlement process between merchandisers and manufacturers for all electronic coupon records received by the central organization that day comprising the following processes;
merchandisers are reimbursed and manufacturers charged for all coupon rebates with which they are associated,
a historical database of electronic coupon records processed during settlement is updated and used for reporting processing results to consumers, manufacturers and merchandisers by the central organization and for supporting inquiries,
the central organization uses bank router information maintained for all merchandisers and manufacturers so daily payment totals and reimbursement totals can be computed based on daily activity and electronic fund charges and payments are sent to the manufacturers and merchandisers bank accounts as part of the settlement process.
